(19) United States
(12) Patent Application Publication
(10) Pub. No.: US 2004/0243445 A1
(43) Pub. Date: Dec. 2, 2004

(54) System and method for scheduling pharmaceutical prescriptions

(76) Inventor: Astrid I.-S. Keene, San Francisco, CA (US)

Correspondence Address: CARR & FERRELL LLP, 2200 GENG ROAD, PALO ALTO, CA, 94303, US

(21) Appl. No.: 10/858,923

(22) Filed: Jun. 1, 2004

Related U.S. Application Data
(60) Provisional application No. 60/474,363, filed on May 30, 2003.

(51) Int. Cl. G06F 17/60

(52) U.S. Cl. 705/2

(57) ABSTRACT

The present invention provides a system and method for scheduling pharmaceutical prescriptions. In accordance with various embodiments of the present invention, a schedule module compiles data and creates a customized medication schedule for each patient which is easy to understand. The data used to create the schedule include patient personal profile data, medication and food supplement data, and personal administrative data.

### CROSS-REFERENCE TO RELATED APPLICATION

The present application claims the priority and benefit of U.S. Provisional Patent Application Ser. No. 60/474,363 entitled “System and Method for Scheduling Pharmaceutical Prescriptions,” filed May 30, 2003, which is hereby incorporated by reference. The present invention is also related to co-pending patent application Ser. No.______, entitled “System and Method for Labeling Pharmaceutical Prescriptions” filed Jun. 1, 2004, which is incorporated by reference.

### BACKGROUND OF THE INVENTION

1. Field of the Invention

The present invention relates to healthcare and to the pharmaceutical field, and more specifically, to minimizing errors in prescribing, dispensing, and administering medication.

2. Description of Related Art

Recent studies by the U.S. Institute of Medicine show that nearly half of all American adults—90 million people—have difficulty understanding and using health information, and there is a higher rate of hospitalization and use of emergency services among patients with limited health literacy. Limited health literacy may lead to billions of dollars in avoidable health care costs.

A report released by the Journal of the American Pharmaceutical Association reports a typical pharmacy filling 250 prescriptions daily makes an average of four mistakes. An estimated 3 billion prescriptions will be prescribed and dispensed in 2004 (for 2005 the number is expected to be over 5 billion). That means that about 51.5 million errors occur just by dispensing medication each year, with 3.3 million of them potentially serious or deadly.

These and similar studies about medical and medicine errors are conducted in hospitals and other medical facilities, and therefore restrict the studies' focus on activities primarily performed by skilled personnel (doctors, nurses, pharmacists, etc.). These skilled personnel are highly educated and are equipped with the latest in technology and security systems to minimize errors in medicating patients. But after leaving the health-care system, patients are often left alone with an unfamiliar, complex medication schedule for administrating pharmaceuticals. Without doctors and/or skilled nurses available to supervise or assist patients, the often complicated, irregular medication plans make it extremely difficult for several risk groups, such as AIDS patients, senior citizens, persons with diminished capacities (i.e., mental and/or physical) including poor eyesight, and persons with limited or negligible knowledge of the written English language (or native language of a specific country in which they reside).

For example, AIDS patients are often faced with being prescribed complicated, often changing, irregular schedules to self-administer medication. Typically, a dozen or more medications are necessary every day to keep the patients' immune systems in balance. Depending on a patient's stage of the disease, additional medications may be required for each opportunistic infection. Furthermore, AIDS patients commonly become incapacitated suddenly, thereby requiring family, friends, and other nonprofessionals to step in and take over the medication administration at any time without training or any other specialized knowledge to ensure errors are minimized.

The number of prescription drugs per person has risen immensely during the last couple of years. The largest demographic group is comprised of senior citizens, who are typically aged 60 years or older. Seniors consume about 40% of prescribed drugs. Frequently, seniors are overwhelmed with their deteriorating health and/or simply can no longer deal with the sophisticated medication schedules. Regardless, seniors are vulnerable to the risks of mis-medication or over-medication, even if the patient resides in a retirement or convalescent home. Most retirement homes have established systems for prescribing, dispensing, and administering medication, but have not created an easily readable or understandable and secure system for preventing improper dosages or over-medication. Nursing personnel in such facilities may be less educated and understand little English, (or the native language of a specific country in which they reside) which exposes patients to additional risk of medical errors.

As a further example, patients with poor eyesight have difficulty reading prescription labels, and supplemental textual print-outs describing such medications are often too small to read. Moreover, the typefaces of the print are not user friendly. Oftentimes, specific instructions from the prescribing physician do not appear in automated medication print-out texts. Additionally, conventional administering systems are not suitable for patients who are blind, even if a patient can understand Braille.

Furthermore, patients with limited comprehension of the English language (or the native language of a specific country in which they reside) typically are at risk for errors because of a diminished ability to follow their own prescription schedules.

FIG. 1A and FIG. 1B depict two examples of conventional medication schedules typically used to administer medication (e.g., in a nursing home). As shown, each pharmaceutical, drug, medicine, food supplement, vitamin, or the like (collectively described herein as “medication”) is identified only by difficult-to-read font and with abbreviations not typically understood by patients. Counter-intuitively, each “X” represents a “skip date,” rather than an “administer date” (denoted by a blank). Thus, a patient and/or nurse can easily become confused as to the dates to administer the prescribed drugs.

In a further conventional example, FIG. 1C illustrates a handwritten list of medications given to the patient at time of discharge. No alphabetical or chronological order is provided to support the patient or caregiver. Furthermore, the handwriting may be illegible or difficult to read, especially for older patients with poor eyesight.

Therefore, there is a need for safeguard mechanisms to adequately reduce the risks prevalent in prescribing, dispensing, and administering medication.

### SUMMARY OF THE INVENTION

The present invention provides a system and method for scheduling pharmaceutical prescriptions and food supplements, such as vitamins and minerals. In accordance with various embodiments of the present invention, a computer-implemented process as described herein reduces the risk of mistakenly taking or giving medication due, for example, to irregular schedules of administering drugs.

In one embodiment, a method is provided to manipulate data representing images and other information to generate, among other things, a schedule for administering medicines, food supplements, etc. For example, the method organizes pictograms and graphical images of prescribed medications and food supplements (e.g., minerals, vitamins, etc.) of a patient. It is a user friendly, easy to follow medication-providing system. By working with visual images, a user can more quickly recognize important information than if it is identified only in text.

The medication and food supplement information describing items to be dispensed can be provided by a medication reference and picture library, which is a database for all FDA approved medications and food supplements. Further, this database includes data representing images/photos (e.g., color) or detailed drawings of medication, which can display an item at all angles and perspective views for more accurate identification of the medication. Animated images are available for 360 degree viewing if necessary to identify medications and food supplements.

For each of the pharmaceuticals, food supplements, etc. stored in the Medication Reference and Picture-Library, dosage graduations, sizes, etc. are available. Changes in product appearance, dosages and other information specific to an item (i.e., pharmaceutical, drug, medicine, food supplement, vitamin, or the like) can be updated quickly and at low cost over secure lines from the internet or other data carriers. In one embodiment, an automated voice feature pronounces the name of the medication and provides a brief description of usage to ensure that the correct medication is entered into the schedule and is administered.

The method and system provides a computing system which easily establishes and generates a medication regimen. In combination with the information derived from the medication reference and picture library, a crossover and allergic reaction test (Drug Utilization Review, DUR) module performs drug to drug comparison to determine whether to prescribe a particular drug and/or food supplement to a patient. The crossover and allergic reaction test (DUR) module includes a set of program instructions, that when executed, helps to reduce the risk of over- and mis-medication, detrimental drug interactions, overdoses, and other unfortunate side effects.

The medication reference and picture library can also include data representing machine-readable identifiers, such as a bar code, that are commonly used by the pharmaceutical industry, food supplement manufacturers, and advanced health care facilities for each medication unit to accommodate participants that have a bar code system. Each bar code represents a specific type of medication and/or patient specific prescription.

### BRIEF DESCRIPTION OF THE DRAWINGS

FIGS. 1A and 1B are examples of prior art medication schedules;

FIG. 1C is an example of a prior art handwritten medication list;

FIG. 2 is a diagram of an exemplary communications network suitable for implementing an embodiment of the present invention;

FIG. 3 is a diagram of the exemplary computing system of FIG. 2;

FIG. 4 is a diagram of the exemplary databank server of FIG. 2;

FIG. 5 is an exemplary medication provider schedule module, according to an embodiment of the present invention;

FIG. 6A is an exemplary medication schedule according to the present invention;

FIG. 6B is an exemplary pictogram text description page;

FIG. 6C is a table of exemplary pictograms;

FIG. 6D is an example prescription view page;

FIG. 7 is a flowchart of an overall method for generating a medication schedule, according to one embodiment of the present invention;

FIG. 8A is an exemplary flowchart for handling patient personal profile data;

FIG. 8B is an example patient profile page;

FIG. 9 is an exemplary flowchart for creating patient personal medication and food supplement data;

FIG. 10 is an exemplary flowchart for testing crossover and allergic reaction;

FIG. 11 is an exemplary flowchart for creating patient personal administrative data;

FIG. 12 is an exemplary flowchart for generating the medication schedule; and

FIG. 13 is an exemplary flowchart for assembling the medication schedule.

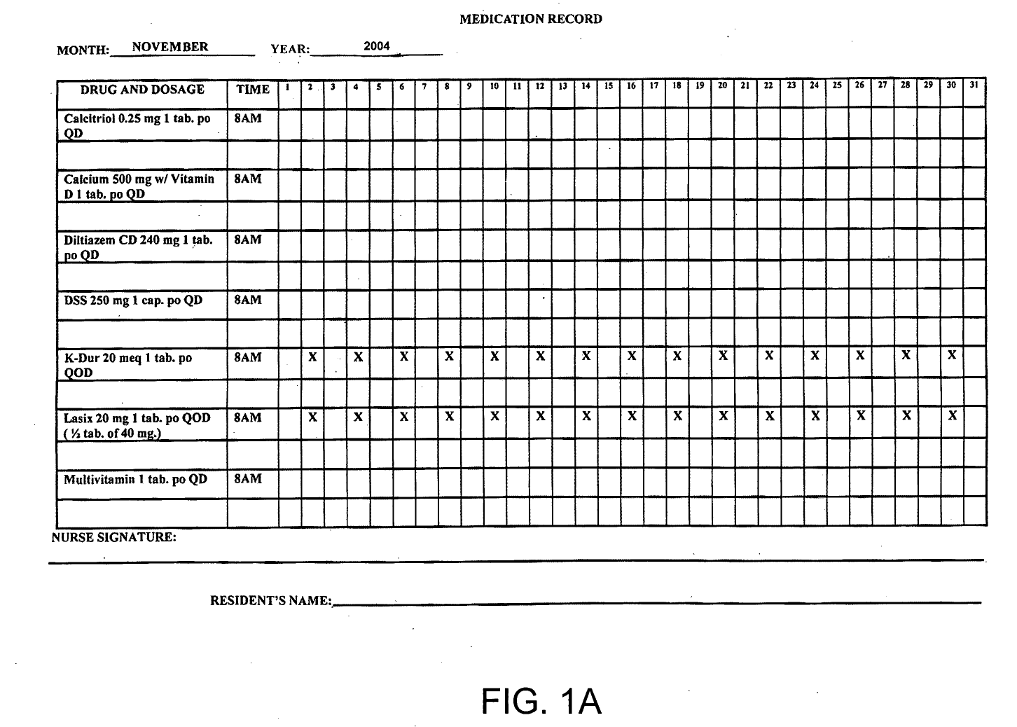

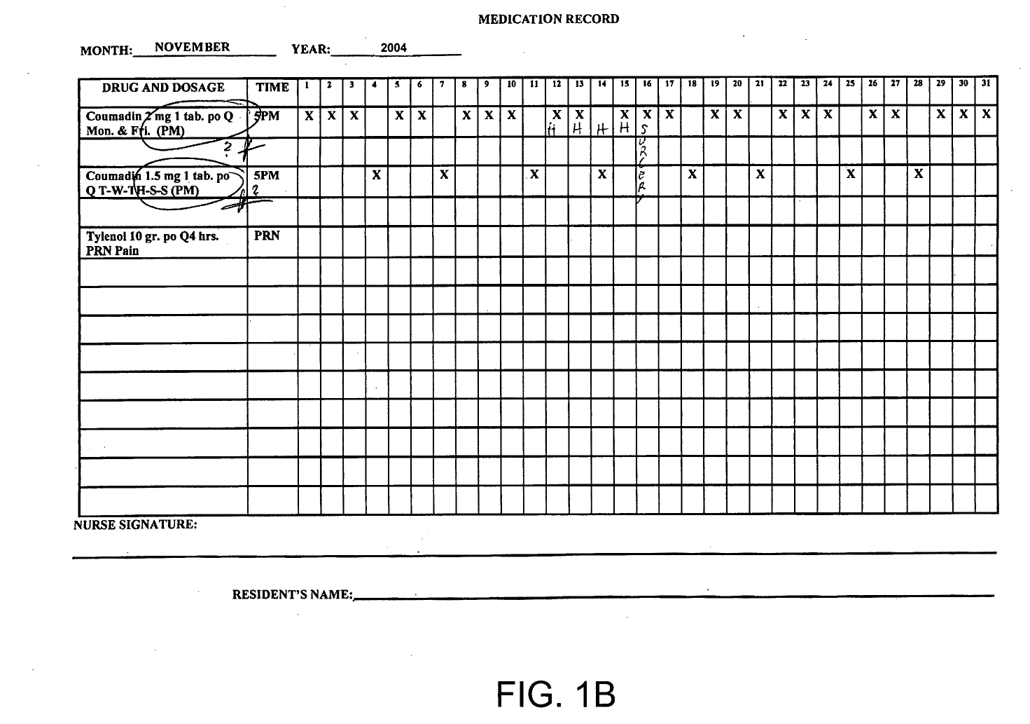

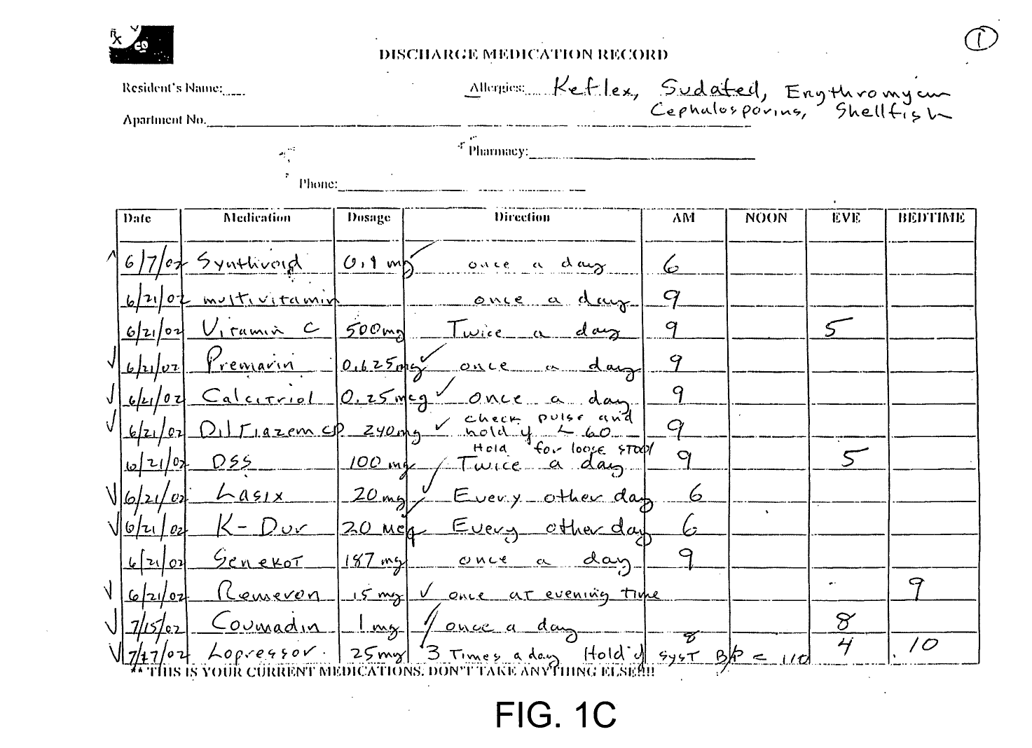

### DESCRIPTION OF EXEMPLARY EMBODIMENTS

The present invention provides a system and method for scheduling pharmaceutical prescriptions and/or food supplements, such as vitamins and minerals. In accordance with various embodiments of the present invention, a computer-implemented process as described herein reduces the risk of mistakenly taking or giving medication at a wrong time or with a wrong dosage.

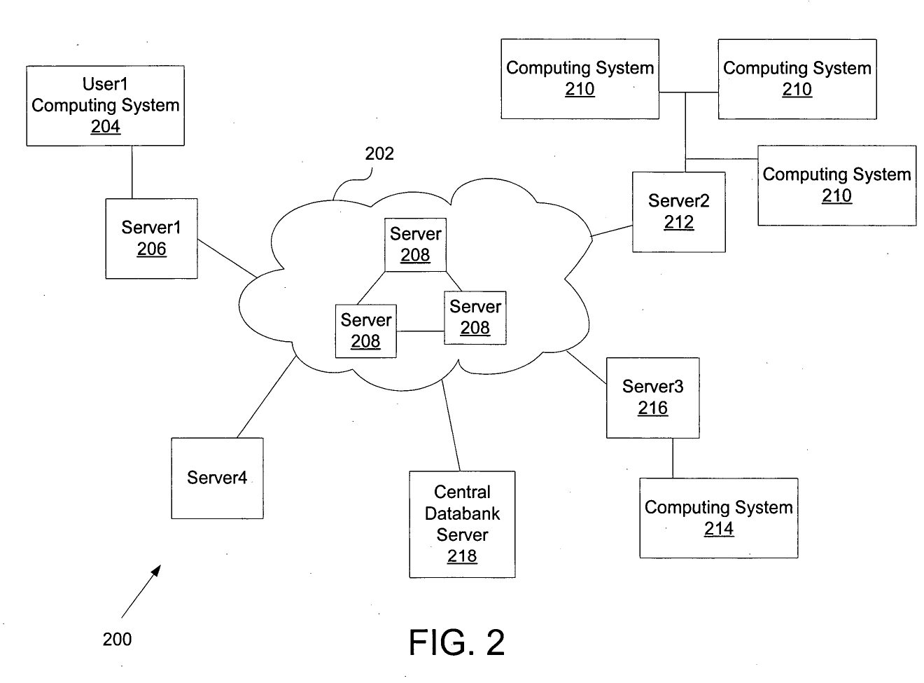

Referring now to FIG. 2, a generalized diagram of an exemplary network 200 in which the present invention may be practiced is shown. In FIG. 2, the network 200 comprises several local networks coupled to the Internet 202. Although specific network protocols, physical layers, topologies, and other network properties are presented herein, the present invention is suitable for use with any data communications network.

As shown in FIG. 2, a User1 computing system 204 is connected to a Server1 206 which in turn is coupled to the Internet 202. The User1 may be a network participant or a patient. The connection to the Internet 202 can be by a network, such as Ethernet, Asynchronous Transfer Mode, IEEE standard 1553 bus, modem connection, Universal Serial Bus, etc. The communication link need not be a wire but can be infrared, radio wave transmission, etc. The Internet 202 is shown symbolically as a collection of server routers 208. In an alternative embodiment, the User1 computing system 204 can be connected directly to the Internet 202. The connection of the Server1 206 to the Internet 202 is typically by a relatively high bandwidth transmission medium such as a T1 line, a T3 line, Metro Area Ethernet, or the like. Similarly, other computing systems 210 are shown utilizing a local network at a different location from the User1 computing system 204. The other computing systems 210 are coupled to the Internet 202 via a Server2 312. Similarly, a User3 computing system 214 and a Server3 216 represent yet a third installation.

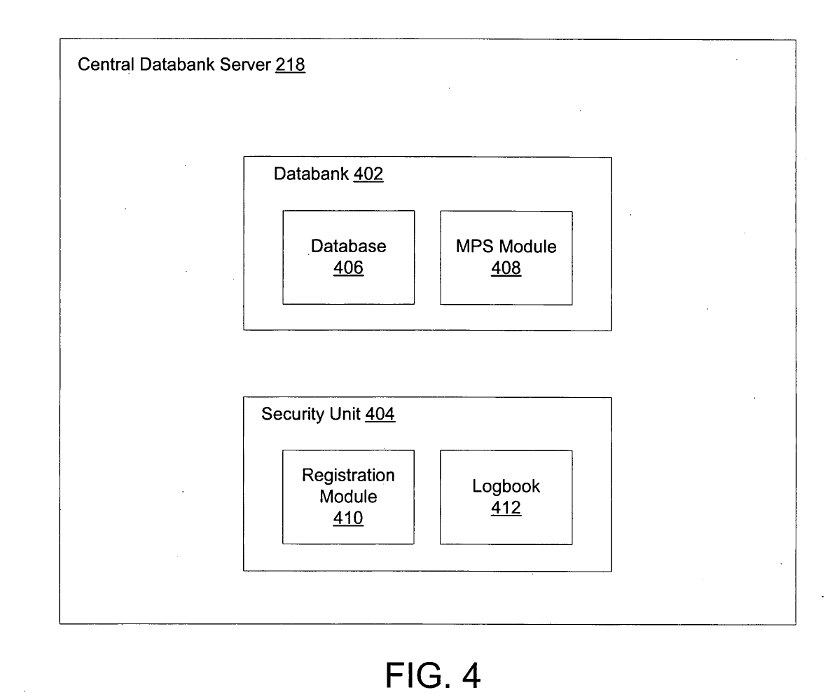

The network 200 further comprises a network central databank server 218 coupled to the Internet 202. The network databank server 218 is a high capacity server that stores network data such as every patient's personal data file. The databank server 218 will be discussed in further detail below in connection with FIG. 4.

Note that the use of the Internet for distribution or communication of information is not strictly necessary to practice the present invention but is merely used to illustrate a specific embodiment. Further, the use of server computers and the designation of server and client machines are not crucial to an implementation of the present invention. For example, the present invention may be self contained within a LAN or single computing system. Additionally, more users/participants and servers may be coupled to the network 200.

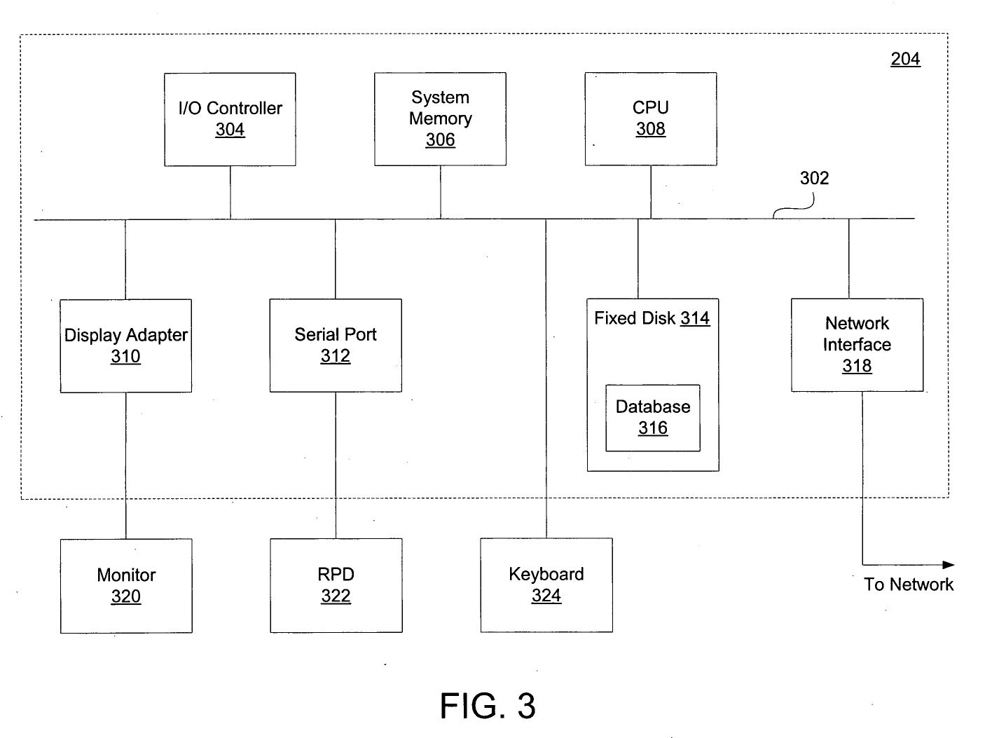

FIG. 3 illustrates the exemplary computing system 204 in more detail. In one embodiment, the computing system 204 comprises a plurality of components which are directly interfaced to an internal bus 302. The components include an input/output (I/O) controller 304, a memory 306, central processing unit (CPU) 308, a display adapter 310, at least one serial port 312, a fixed disc 314 comprising a database 316, and a network interface adapter 318, which in turn is coupled electrically to the network. The use of the bus 302 allows each of the components to transfer data among themselves and, most importantly, with the CPU 308. The CPU 308 may be a Sparc™, an Intel CPU, a PowerPC™, or other equivalent unit. Additionally, external devices can communicate with the CPU 308 or other components via the bus 302 by interfacing with one of the components coupled to the bus 302. Thus, a monitor/screen/display 320 couples with the display adapter 310, and a relative pointing device 322 (e.g. a touch screen or a mouse) couples through the serial port 312. Further devices such as a keyboard 324 may communicate with the CPU 308 by direct means as, for example, via an interrupt controller and associated registers. In exemplary embodiments, the database 316 may comprise a local databank (similar to a network databank) of patient information. In yet a further embodiment, a local databank may be externally coupled to the computing system 204.

It should be noted that the embodiment of FIG. 3 is exemplary. Components or devices in addition to or other than those shown in FIG. 3 may be utilized. Alternatively, a suitable computing system 204 can be achieved without using all of the components shown in FIG. 3. For example, a stand-alone computer need not be coupled to a network, so the network interface 318 is not required. Other components such as a CDROM drive, graphics accelerator, etc. can be included in the configuration without affecting the performance of the computing system 204.

Referring now to FIG. 4, the exemplary central databank server 218 is shown in more detail. The databank server 218 comprises a databank 402 and a security unit 404. The databank 402 comprises a database 406 and a medication provider schedule (MPS) module 408. In one embodiment, the databank 402 stores software (e.g., within the MPS module 408) for implementation of the present invention. Thus, a network participant (e.g., hospitals, doctors, pharmacies, and other professional health personnel) may download the software of the MPS module 406 over secure lines via the Internet 202 (FIG. 2) for storage and/or utilization on their local computing system 204. In a further embodiment, the participant does not need to have the software stored and/or loaded on their local computing system 204, but may work online over secure lines of the Internet 202 by running the software in the MPS module 408 directly on the databank server 218. Alternatively, the software may be read from a CD-ROM or other storage medium. When upgrades to the system (e.g., upgrades to modules of the MPS module 406) are required, the participant may obtain the upgrades via the same methods (e.g., download over the Internet 202 from the network databank server 218).

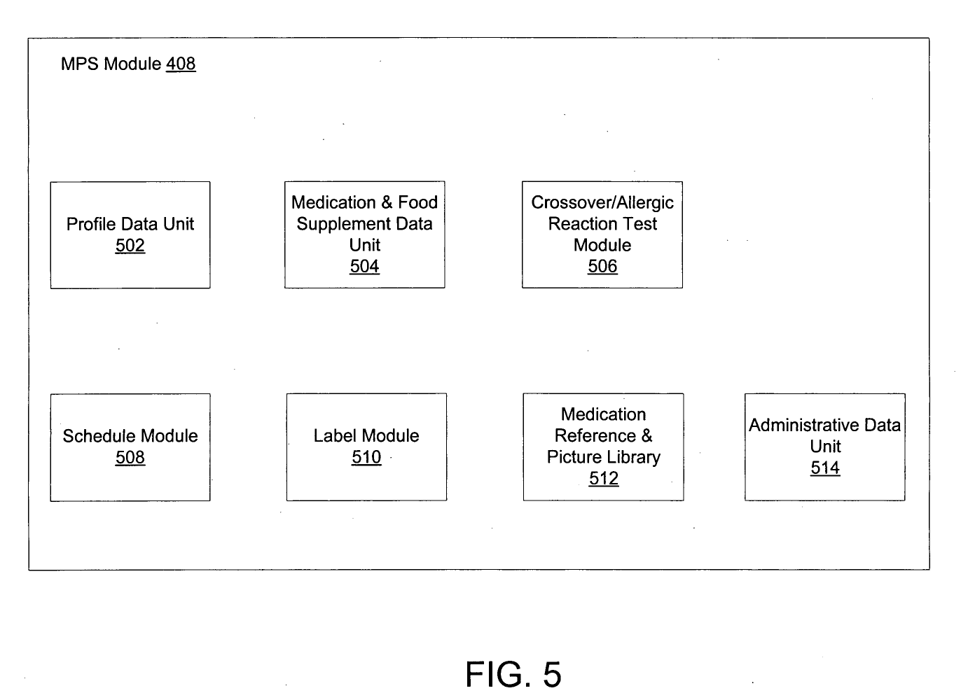

The MPS module 408 further comprises components which create data files utilized by the system in order to generate the medication schedule of the present invention. This aspect of the MPS module 408 will be discussed in more detail in connection with FIG. 5.

In order to access the databank 402, the participant must register with, and provide a correct login to a registration module 410 of the security unit 404. According to one embodiment, the participant will receive or set an ID number (or login name) and a password after a first registration with the security unit 404. Subsequently upon entering the login name and password and verification by the registration module 410, the participant may access the databank 402 to exchange information with the database 406, or to work off the databank server 218 (instead of having the software loaded on the participant's computer). A logbook 412 records all access to the databank server 218 including all activities, data entry, user names, and locations. In a further embodiment, a patient may access their own records stored on the databank. server 218 via the Internet 202. These patient accesses may also be logged in the logbook 412.

The database 406 of the databank 402 stores patient data files. Initially, the patient authorizes the participant to establish his/her personal data file. The data in the file may include personal profile data such as full name of patient, social security number (which may be encoded for protection), date of birth, place of birth, picture of the patient, sex, allergies, health insurance, medical records, etc. Additionally, data may be stored for a patient's personal medications and food supplements and for a personal illustrated schedule. Further embodiments may store other forms of information in the database 406. The participant may receive or enter the data via their user computing system (e.g., 204). Alternatively, data can be provided or received via cell phone, palm, or other computing devices.

In exemplary embodiments, the patient's data file may be stored at the local computing system database 316 (FIG. 3) or other local databanks, in addition to, or instead of being stored at the network databank 402. This allows the participant to work offline. In these embodiments, access by the participant on their computing system 204 and activation of the corresponding software may result in an entry in the logbook 412 on the databank server 218 or a similar logbook of the local databank. This insures that a complete access record is kept.

Referring now to FIG. 5, the MPS module 408 is shown in more detail. As previously discussed, the modules of the MPS module 408 may be downloaded and stored locally for use on a computing system, or accessed for operation on the central server 218 (FIG. 2). The exemplary MPS module 408 comprises a patient profile data unit 502, a medication and food supplement data unit 504, a crossover/allergic reaction test (DUR) module 506, a schedule module 508, a label module 510, and a medication reference and picture library 512. In alternative embodiments, more, less, or other modules and units may be embodied in the MPS module 408. For example, a further embodiment may comprise an optional administrative data unit 514 which uses data such as bar codes, RX refill numbers, refill due dates, and number of refills to create an administrative data file used for populating a schedule and/or label, according to the present invention.

The profile data unit 502 creates and maintains a patient's personal profile. The personal profile comprises data such as patient name, social security number (which may be encoded for protection), date of birth, place of birth, a picture of the patient, sex, allergies, health insurance information, medical records, and any other information relevant to the patient's medical condition and treatment. This information may be received from the patient, the participant, or the database 406 (FIG. 4).

The medication and food supplement data unit 504 uses information such as name of medication, dosage, amount, directions, time of allocation, and so forth to establish a complete list of all medications and food supplements for a particular patient. The information may be supplied by the patient, supplied by the participant, or obtained from the database 406.

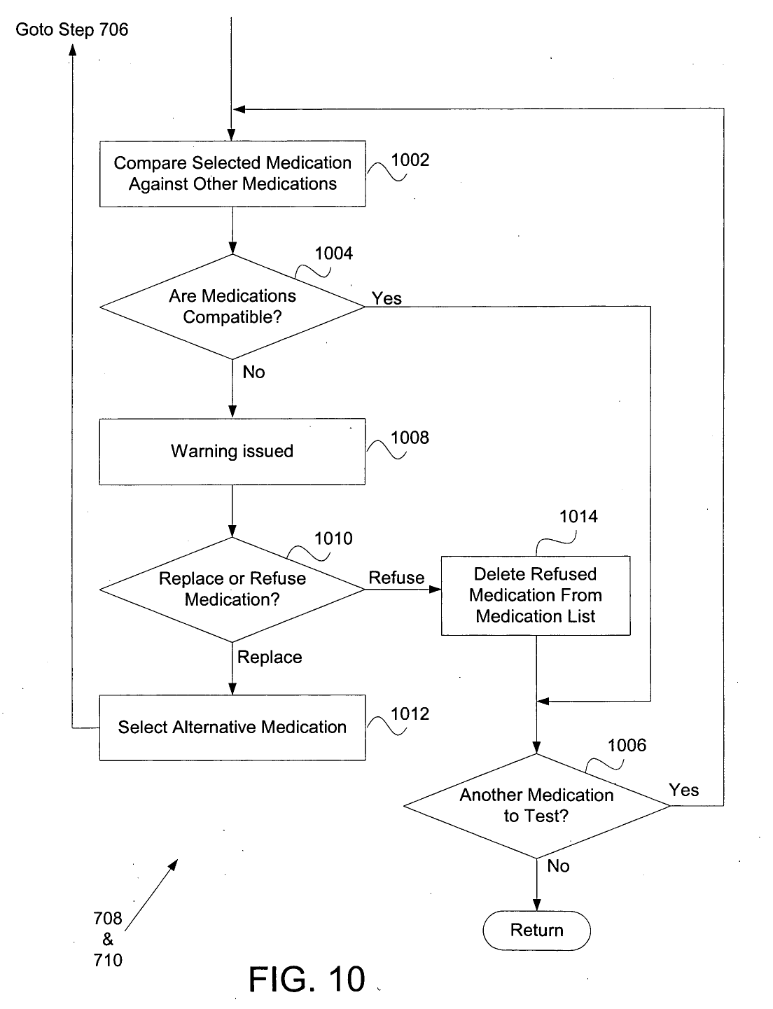

The crossover/allergic reaction test (DUR) module 506 checks prescribed and/or self-administered medications and food supplements, such as vitamins and minerals, taken by the patient to insure no adverse effects will occur. If an adverse effect will occur, the system will, in exemplary embodiments, access the medication reference and picture library 512 for recommendations for an alternative medication. The crossover/allergic reaction test will be discussed in more detail in connection with FIG. 10

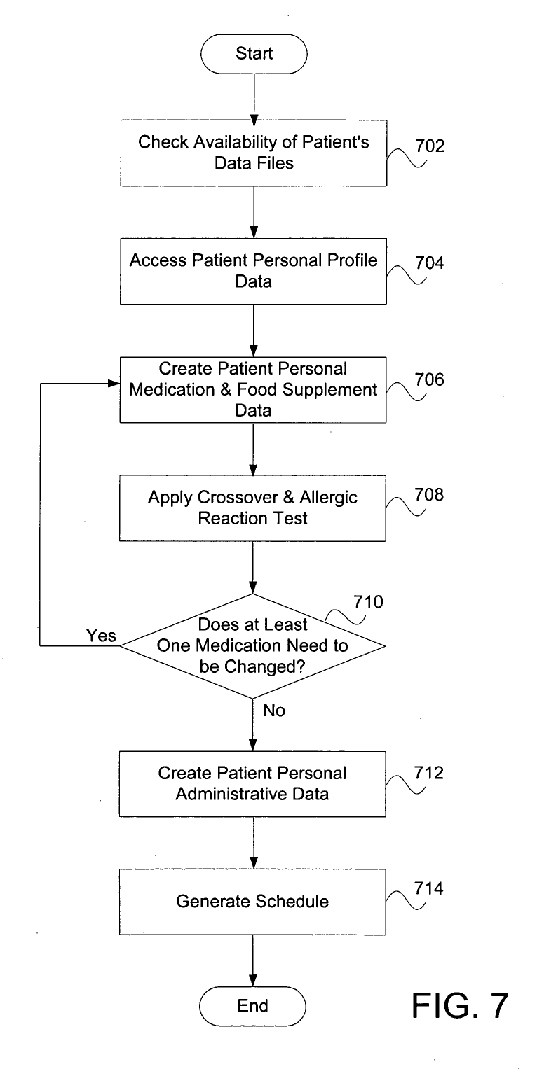

Based on the data obtained and/or created by the profile data unit 502, the medication and food supplement data unit 504, the crossover/allergic reaction test module 506, and the optional administrative data unit 514, the schedule module 508 generates a medication schedule for the patient. The schedule module 508 (FIG. 5) generates this schedule by organizing all the provided information into a suitable format form for each individual patient based on the patient's and/or caregiver's needs and abilities. In one embodiment, the schedule module 508 uses color images/illustrations such as photos or elucidated drawings of medication/food supplements or the like to clearly identify such medications. Further, directions or warnings for taking of the medication can be illustrated through the use of pictograms. Additionally, the pictogram can be supplemented with further directions such as, but not limited to, “take with food,” “take with water,” “do not take with alcohol.” The schedule generation process will be discussed in further detail below in connection with FIGS. 7, 12, and 13.

In a corresponding process, labels for the medication are generated by the label module 510. These labels will coordinate with the schedule. For example, both the schedule and the label may use the same illustrations and pictograms for the medication, directions, and warnings, thus allowing the patient to match the correct medication to the schedule.

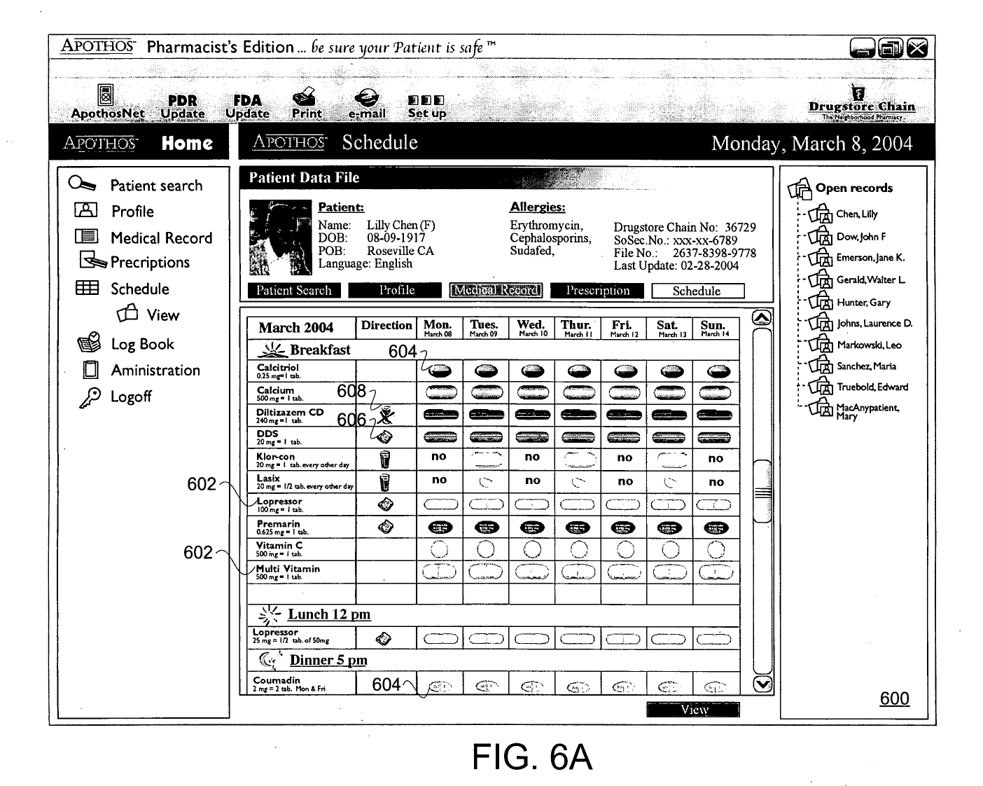

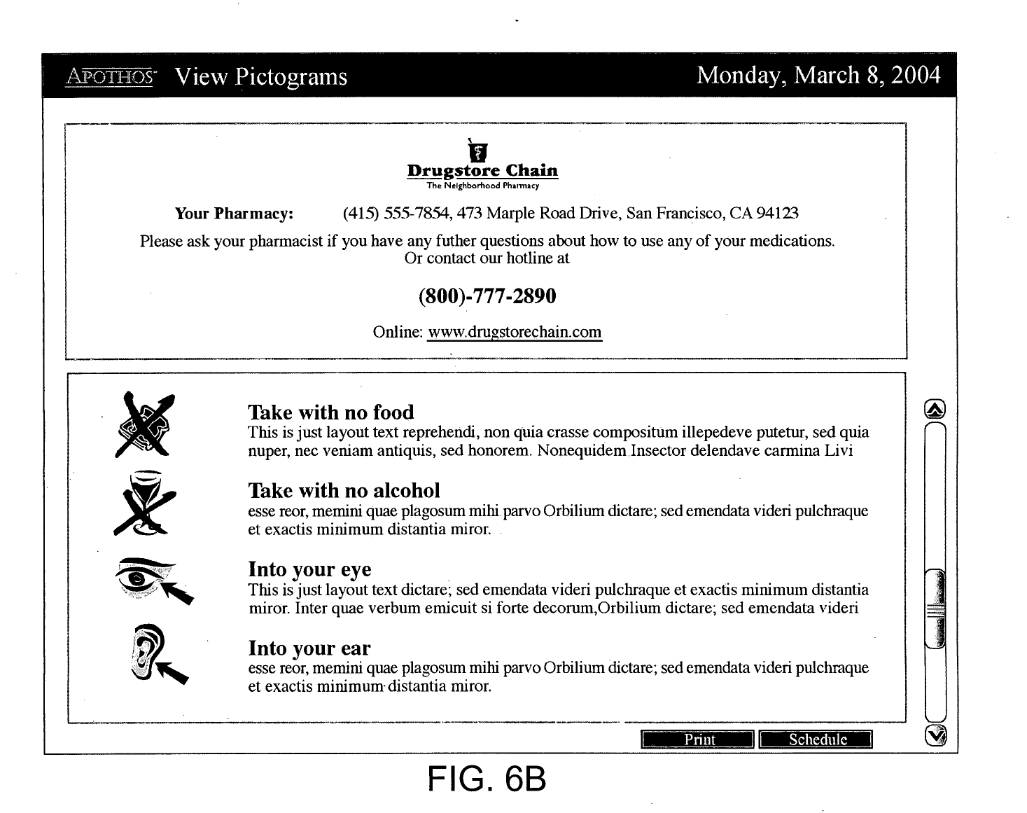

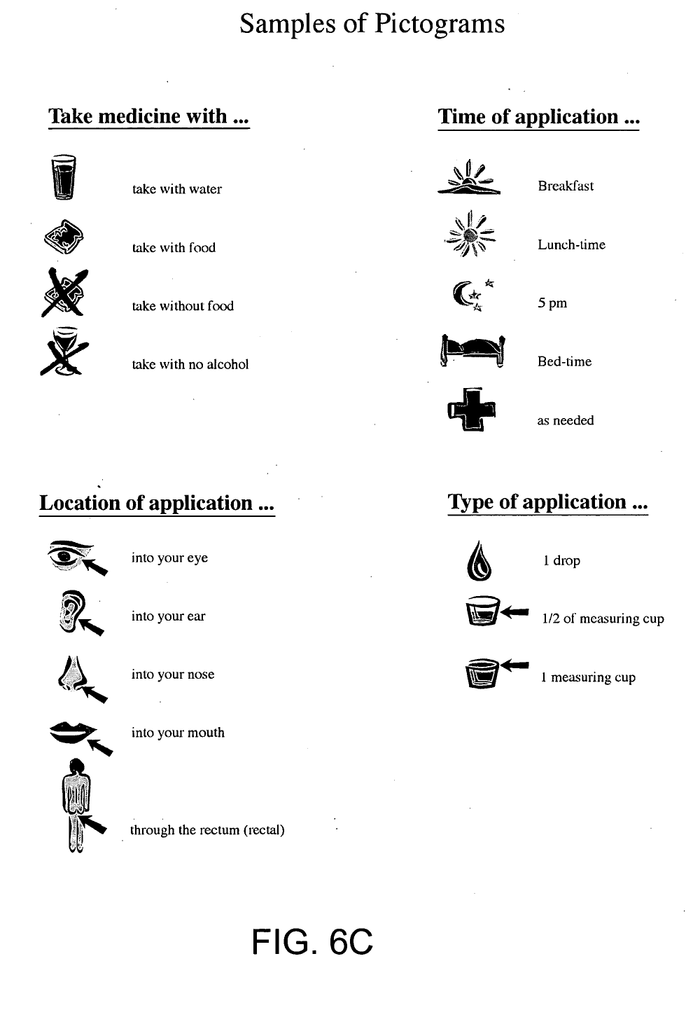

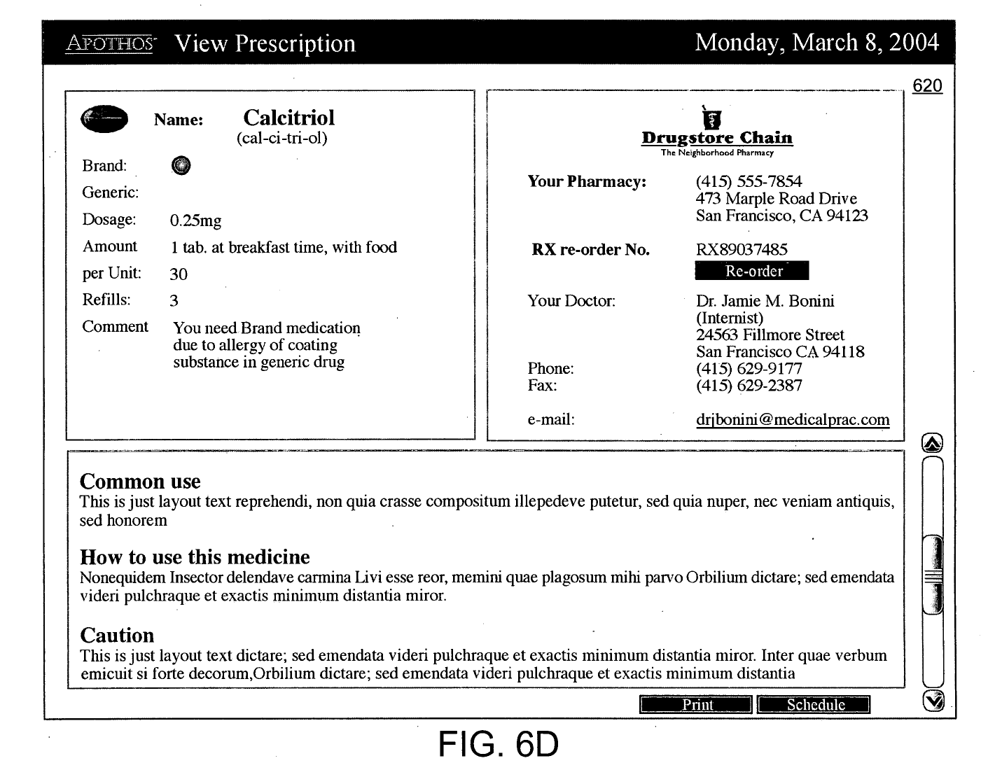

Referring now to FIG. 6A, an exemplary illustrated patient personal illustrated medication provider schedule 600 (the “schedule”) is shown on a display of the computing system 204 (FIG. 2). According to exemplary embodiments, the schedule 600 is a table describing procedures to take prescribed medications and/or food supplements (e.g., what time, which medication, how much of the medication, etc.). For example, the schedule 600 may be organized by specific time(s) of the day (in hours or meals), week, month, or other special time(s) or occasions, specific brand/generic medications, specific dosage(s) of the medication, specific amount(s) of the medication, specific direction(s) how to take medication(s), and so forth.

The presentation of the schedule 600 can be varied so as to adapt to a patient's/caregiver's specific needs (e.g., it can be organized by day, hour, type of medication, frequency of use, before or after meals, or any other way). The presentation type depends on an ability of the patient and/or the place/institution the schedule 600 will be used. The schedule 600 especially supports patients with special needs, temporary or permanent disabilities (e.g., patients whose conditions force them to take a great number of drugs, complicated drug patterns and combinations), patients with low vision or blindness (e.g., using Braille), patients with limited language comprehension, etc. The schedule 600 can include illustrations of the medications for identification, and uses such illustrations in the form of images and/or photos (e.g. color) or detailed drawings of one or more medications to support a clear identification for patients with sight. In a further embodiment, the schedule 600 also can be adapted to include audio descriptions and/or Braille representations of a medication if the patient has negligible sight, or is blind.

In the embodiment of FIG. 6A, the schedule 600 shows medication that the patient must take with breakfast (i.e., in the morning), lunch, and dinner. This exemplary schedule 600 is provided for one week. However, alternative embodiments may be generated to show the schedule for the entire day (e.g., by meals such as breakfast, lunch, and dinner; by times such as hourly increments; etc.), and the schedule 600 may comprise other time periods (e.g., for two weeks, for the month). As shown, the schedule 600 clearly illustrates to the patient or administrator the medication name 602 and look (i.e., graphical representation 604) as well as whether the medication should be taken on a specific day. For example, Lasix (20 milligrams=½ tablet) is only to be taken on Tuesday, Thursday, and Saturday for this particular week of the schedule 600. Resultantly, there is a less likely chance of the patient taking the wrong medication at an inappropriate time.

The schedule 600 further provides directions for taking the medication. For example, DDS (20 milligrams) should be taken with food as indicated by a pictogram 606 (i.e., the bread pictogram represents food). As a further example, Diltizazem CD should not be taken with alcohol as indicated by a pictogram 608. In an interactive embodiment of this schedule, the patient or participant may click on the pictogram which will bring up text directions corresponding to the pictogram, for example, as shown in FIG. 6B. In further embodiments, the pictograms may be illustrations having multiple angles, be enlarged, and be animated for viewing. An exemplary table of applicable pictograms is shown in FIG. 6C. Pictograms in addition to those shown in the table are contemplated and may be used in accordance with the present invention. Additionally, more than one pictogram may be provided for a single medication or food supplement.

The schedule 600 may be printed out by the participant, and when applicable, given to the patient (or printed by the patient). Alternatively, the participant and/or the patient (and/or the patient's caregiver) may access the schedule via the Internet. In this embodiment, the schedule is interactive. For example, by clicking on a graphical image 604 of one of the medications, further information is provided in a view prescription page. FIG. 6D is an example of a view prescription page 620. The prescription page 620 may comprise specific information on the medication (e.g., image, dosage, amount to be taken, directions for taking, and comments), pharmacy and physician information, common use, cautions, and possible side effects. The prescription page 620 also enables the participant and/or the patient (and/or the patient's caregiver) to re-order the prescription over the internet.

Referring now to FIG. 7, an exemplary flowchart of one method for generating the schedule 600 (FIG. 6a) is shown. In step 702, the participant checks the availability of a particular patient's data files. According to one embodiment, the participant accesses the local MPS module (i.e., the local MPS module on the computer system 204 of FIG. 2), and checks for availability of the patient's personal data file in the local databank. The participant may also log onto the network central databank 218 (FIG. 2) by providing an authorized user name and password which is verified by the security unit 404 (FIG. 4). Data or data updates for the particular patient's data file may then be transferred from the central databank 402 to the participants computing system 204 (FIG. 2) and stored in the local databank or database 316 (FIG. 3). These updates may comprise information from other participants on the network. For example, the patient may have different physicians with different specialties. Each physician may write prescriptions locally and the central databank 402 collects all the information. In one embodiment, the computing system 204 is a server located on premises of the participant, and operates, among other things, to store patient personal data files established on the premises and/or retrieved from the network central databank 218. The personal data files include the patient's personal profile data, existing patient's personal medication and food supplement data, and existing patient's personal illustrated provider schedule data.

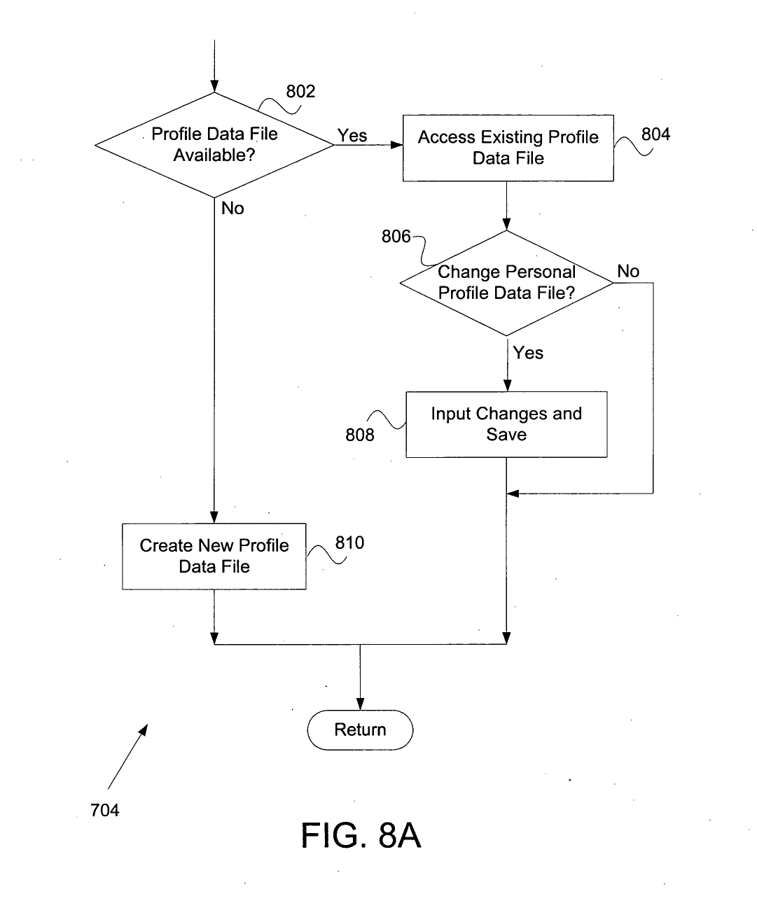

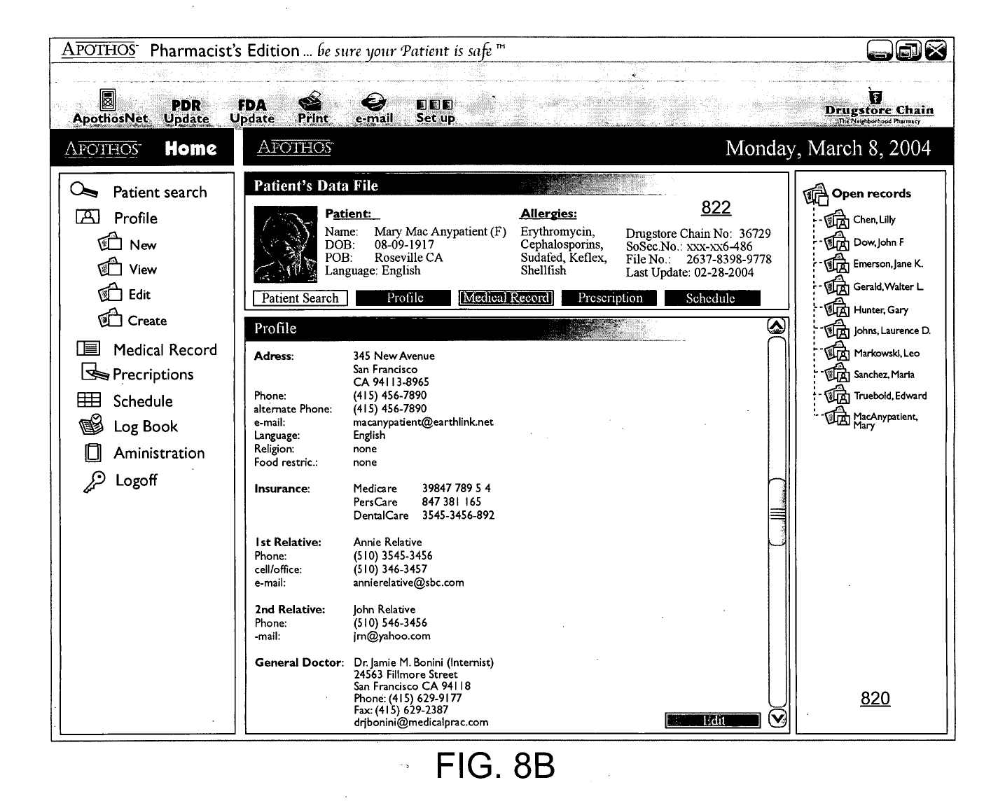

In step 704, the participant accesses the patient's existing personal profile data. The participant may view and/or update the existing personal profile data, which may be established previously by another participant. If the personal profile data is not available (e.g., not previously established), the participant may create a new personal profile data file via the profile data unit 502 (FIG. 5). This step will be discussed in more detail in connection with FIG. 8.

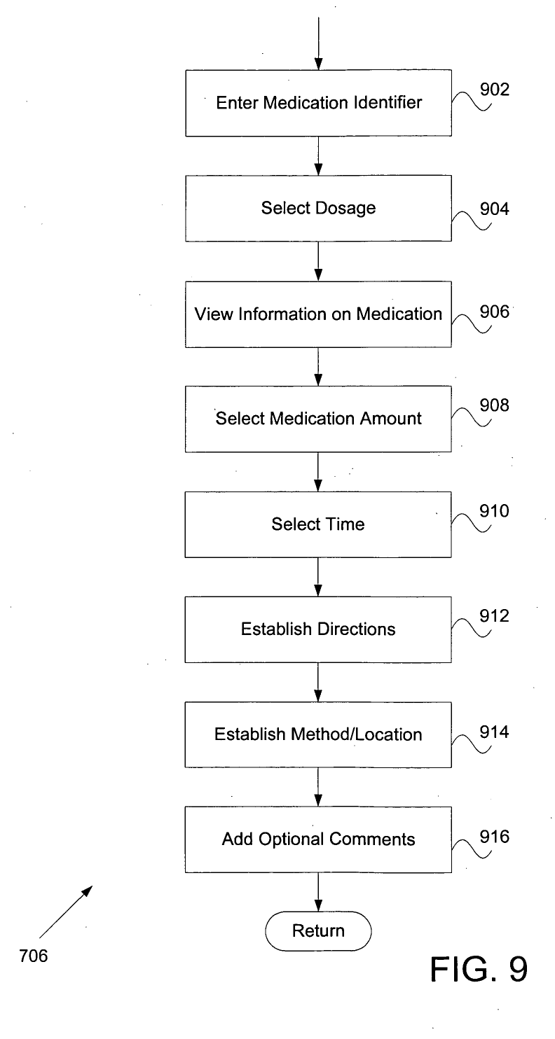

Patient personal medication and food supplement data is then created in step 706. In this step, the participant enters new medications into the system for the patient. This step will be discussed in more detail in connection with FIG. 9.

The crossover and allergic reaction test (DUR) is applied in step 708 and a determination is made as to if at least one medication needs to be changed based on the results of the crossover and allergic reaction test (DUR) in step 710. If at least one medication needs to be changed, then the participant repeats the steps of creating the patient personal medication and food supplement data (step 706) and applying the crossover and allergic reaction test (DUR) (step 708). However, if no medications need to be changed, then the participant may create or update the patient personal administrative data in optional step 712. Steps 708 and 710 will be discussed in more detail in connection with FIG. 10.

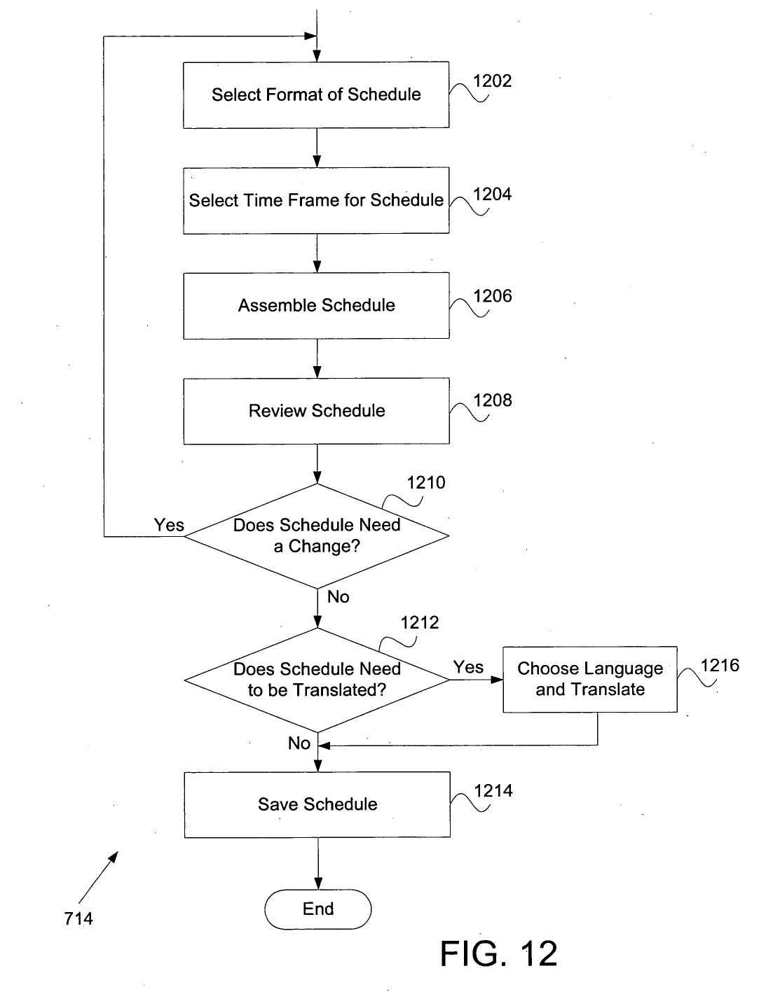

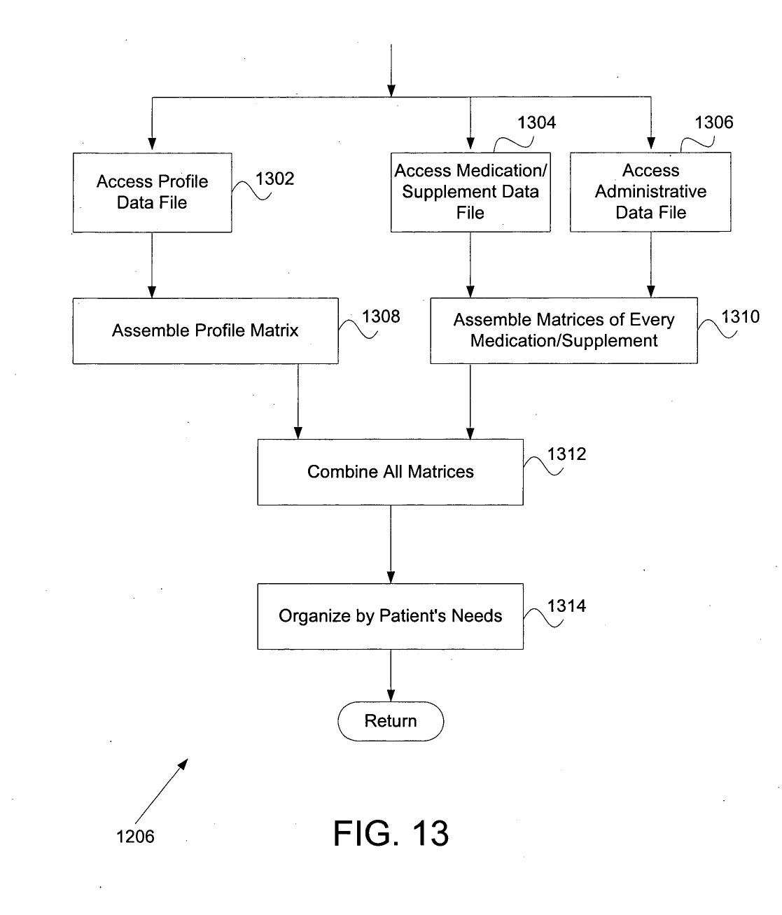

In step 714, the schedule is generated. A more detailed discussion on the generation of the schedule is provided in connection with FIGS. 12 and 13 below.

It should be noted that the method of FIG. 7 is exemplary. Alternative embodiments may perform more, less, or alternative steps to achieve the same results. For example, checking the availability of the patient's data file (i.e., step 702) may not be required in an embodiment where the computing system 204 is the local or network server. Additionally, some steps may be practiced in a different order or not practiced. For example, if the participant merely wants to generate and print a schedule without prescribing a new medication (e.g., refilling existing medication), the crossover and allergic reaction test of steps 708 and 710 may need not be practiced. Further to this example, step 706 only accesses stored medication and food supplement data.

Referring now to FIG. 8A, an exemplary flowchart for handling patient personal profile data is shown. According to one embodiment, the computing system 204 (FIG. 2) checks if the patient's personal profile data is available in step 802. If the profile data is available, then the personal profile data file is accessed in step 804. The participant may then view the data in the profile data file. If changes and updates are needed in step 806, the participant may input and save the changes in step 808.

Should the personal profile data file not be available in step 802, the participant will create a new profile data file in step 810 via the profile data unit 502 (FIG. 5). Accordingly, the participant may be prompted to enter data such as the patient's picture, medical history, encoded Social Security Number, file number, and other pertinent information. Based on the information, the patient's personal profile data file is established.

Referring now to FIG. 8B, an exemplary patient profile page 820 created from the personal profile data is shown. In exemplary embodiments, the MPS module 408 (FIG. 4) produces and presents a graphical user interface which includes the personal profile data (e.g., a header 822 on top of each page of information for the patient). This header 822 may contain a picture of the patient, name, date of birth, allergies and other important personal and medical information. The header 822 may be provided on various data display pages to the participant. The information in the header 822 helps minimize mix-ups which can arise due to commonality of patient's with the same name, same date of birth, misspelled names, and any other similar errors. The patient profile page 820 further comprises profile information such as patient address and contact information, insurance information, and emergency contact information.

Referring now to FIG. 9, an exemplary flowchart of a method for creating or updating patient personal medication and food supplement data (step 706) is provided. The medication and food supplement data file is created and updated by the medication and food supplement data unit 504 (FIG. 5) and uses information from the medication and reference picture library 512 (FIG. 5). The medication and food supplement unit 504 processes information such as name of the medication, dosage(s), amount(s), directions, times(s) of allocation, and so forth. Resultantly, the medication and food supplement unit 504 establishes a list of medications and food supplements to be administered to the patient.

Accordingly in step 902, a medication identifier is entered for a new prescription by the participant. The medication identifier is associated with a specific medication. For example, the medication identifier may be the name or sku number of a brand or generic medication. If the medication identifier is not entered correctly or is not known to the medication and food supplement data unit 504, the participant will be prompted to reenter the medication identifier. In exemplary embodiments, the medication reference and picture library 512 (FIG. 5) is referenced to determine if the medication identifier is correct.

If the medication identifier is entered correctly, the participant is then prompted to select a dosage (e.g., 5 mg) for the medication in step 904. Preset dosages from which the participant may select from (e.g., scroll down list, select one list) may be provided by the medication reference and picture library 512. Alternatively, the participant may provide the dosage by manually entering the dosage into the computing system 204, for example, via the keyboard 324 (FIG. 3).

After the dosage is selected, information concerning the medication is provided in step 906. In one embodiment, images or drawings of the medication/food supplement and a short description of usage appears on the monitor/screen/display 320 (FIG. 3). The images can appear in one or more angles, be enlarged, and be animated for 360 degree viewing. In a further embodiment, an optional automated voice feature pronounces the medication name and may give the participant a brief description of usage. The information is provided to ensure that the correct medication is selected which will be inserted into the schedule. The images, brief descriptions, and other information are provided by the medication reference and picture library 512.

In step 908, the participant selects the medication amount (i.e., number of tablets or ml). Preset amounts from which the participant may select from may be provided by the medication reference and picture library 512. Alternatively, the participant may provide the amount by manually entering the amount into the computing system 204. In this instance, the participant is able to establish an irregular or customized amount.

The participant selects time(s) that the medication should be administered in step 910. The time(s) may be selected from a preset time(s) selection provided by the medication reference and picture library 512, or may be provided by the participant/physician. In exemplary embodiments, the participant first selects the time(s) of the day to administer the medication. Then, the participant selects the time(s) of the week for medication administration. For example, the medication may be administered at breakfast every other day. In further embodiments, a calendar is provided from which the participant may select days for administering the medication, for example, during customized, irregular times.

In step 912, the participant establishes directions for taking the medication. For example, the medication may need to be taken with food or not taken with alcohol. In one embodiment, the participant may choose to provide easy-to-recognize pictograms (i.e., illustrated symbolized picture) from the medication reference and picture library 512.

In step 914, the participant establishes a method or location of application of the medication or food supplement. For example, the medication may need to be applied to the mouth, the nose, or into the ear. In one embodiment, the participant may choose to provide easy-to-recognize pictograms (i.e., illustrated symbolized picture; see FIG. 6c) from the medication reference and picture library 512. Alternatively or in addition, the participant may provide other directions or comments in step 916. In alternative embodiments, steps 912 and 914 may be encompassed within a single step.

Because the participant has the ability to manually enter customized dosages, amounts, times, and directions, the participant may create an irregular or customized schedule. For example, the participant may schedule medication to be administered in alternating segments of time and/or can be allocated in accordance with any time(s) of the day, time(s) of the week, time(s) of the month, dosage(s), amount(s), and direction(s).

It is noted that FIG. 9 describes one embodiment of the method for creating or updating personal mediation and food supplement data. In alternative embodiments, some steps may be performed in a difference order, combined, or not practiced. Additionally, some steps may be automatically performed by the computing system based on information from the medication reference and picture library 512.

Referring now to FIG. 10, an exemplary flowchart of a method for testing for crossover and allergic reaction (steps 708 and 710) is provided. The crossover and allergic reaction test (DUR) performs a check to determine whether there is an incompatible use of two or more medications and food supplements after the list of medications and food supplements have been provided by the participant. In step 1002, one medication is selected for comparison with the rest of the medication on the list. If the selected medication is compatible with the rest of the medication in step 1004, then the crossover/allergic reaction test module 506 (FIG. 5) determines if there is a next medication on the list (step 1006) which needs to be tested for compatibility. If so, then the method returns to the beginning of the test.

If in step 1004, the selected medication is not compatible with one or more of the other medications on the list, a warning is issued in step 1008. Then, the test module 506 will query the participant as to whether at least one of the incompatible medications should be replaced or whether at least one of the incompatible medications should not be prescribed (i.e., refuse prescription) in step 1010. If the participant chooses to refuse prescribing one of the incompatible medications, then the refused medication will be removed from the medication list for the patient in step 1014, and the test module 506 moves on to test a next medication, if one is available. In further embodiments, the refused medication may be replaced with a safe alternative.

If the participant chooses to replace one of the incompatible medications, then an alternative medication is selected in step 1012. In one embodiment, a list of alternative medication may be provided by the medication reference and picture library 512. Alternatively, the participant may manually provide an alternative medication. After the alternative medication is selected, the personal medication and food supplement data is updated and the test module 506 will repeat the test with the alternative medication.

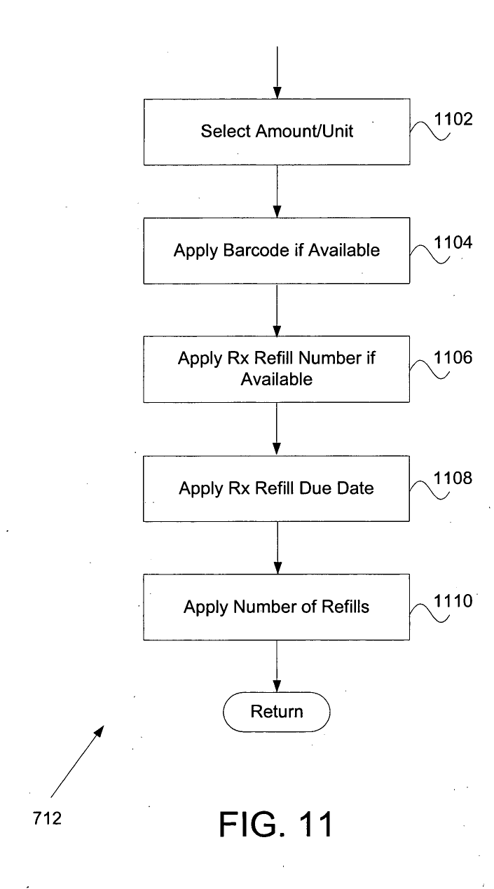

Referring now to FIG. 11, an exemplary flowchart of a method for creating or updating patient personal administrative data is shown. The administrative data is used to ensure both the participant and the patient an efficient and secure future distribution of the medication. According to one embodiment of the present invention, this method is optional when creating a schedule. In step 1102, an amount/unit is selected via the administrative unit. The amount/unit of medication (e.g., per container) may be suggested by the medication reference and picture library 512 (FIG. 5) or entered manually by the participant (e.g., in accordance with a physician's recommendation).

If a barcode or similar machine-readable identifier for a specific medication on the list is available, the barcode or identifier may be applied in step 1104. The barcode or identifier may be chosen from an existing bar code identifier such as those used by the pharmaceutical industry or provided by the medication reference and picture library 512. Alternatively, an internal custom barcode may be generated by the participant for use with the participants own computing system 204 (FIG. 2). An internal custom barcode may be utilized, for example, when the participant has an internal security barcode system such as those commonly used in hospitals.

In step 1106, the participant applies an Rx refill number if one is available. The Rx refill number may be obtained from the participant's computing system databank. This Rx refill number enables the patient to easily reorder medication, for example, via phone, e-mail, the Internet, or other methods.

In step 1108, the participant applies an Rx refill due date if applicable. The Rx refill due date is the day a patient has to reorder his/her refill of the current prescription. The refill due date represents the last day this medication is available to the patient, if medication is taken properly according to the physician's orders. The participant may enter the refill due date manually or the computing system may calculate the due date and apply it automatically.

In step 1110, the participant applies a number of refills if available. The number of refills is the number of times the patient may obtain the prescription as prescribed by the physician without a further prescription. The participant may either manually enter the number of refills or retrieves the number of refills remaining from the computing system databank.

Referring now to FIG. 12, an exemplary flowchart of a detailed method for generating the schedule 600 (FIG. 6) is provided. In exemplary embodiments, the schedule is generated by the schedule module 508 (FIG. 5) of the MPS module 408 (FIG. 4). In step 1202, a format is selected for the schedule 600. For example, the format may be different for an outpatient versus an inpatient depending on the patient's needs. According to one embodiment, the format of the schedule 600 may be chosen from a selection provided by the MPS module 408 via, for example, a scroll through menu. The choice depends upon the ability and needs of the patient and/or location where the schedule 600 will be used. In a further embodiment, the participant may customize the format of the schedule 600 such as size and orientation of the schedule 600, size of fonts, use of more pictograms, etc. For example, a patient may prefer to have the schedule 600 in a larger size due to her/his eyesight disability or a small (wallet) size so as to be able to place the schedule 600 on her/his refrigerator or carry in her/his wallet.

In step 1204, the participant selects a time frame for the schedule 600. The time frame represents the range between a start time and an end time for the schedule 600. The time frame may comprise a week, month, or any other range of time.

Once the format and the time frame have been selected, the schedule module 508 assembles the schedule in step 1206. The schedule 600 is assembled by organizing and arranging the data accessed from the personal profile data file, the personal medication and food supplement data file, and the administration data file, if available. This step will be discussed in further detail in connection with FIG. 13 below.

The participant may then review the schedule 600 (FIG. 6A) in step 1208. In one embodiment, if changes to the schedule 600 are needed, the participant may reselect the format and time frame for the schedule 600. If no changes are needed, then the participant determines if the schedule 600 requires translation in step 1212. If no translation is required, the schedule 600 is saved in step 1214.

In some situations, the schedule 600 will need to be translated. For example, the patient/care giver may not be able to read English, so the schedule 600 will be. translated to the patient's/caregiver's native language. In a further example, the patient may be partially or fully blind. In this situation, the schedule module 508 will translate the schedule into Braille. The MSP module 408 may then save both versions of the schedule 600 (original and translated) for subsequent access in step 1214. The schedule may be printed out for the patient and/or caregiver. Alternatively, the patient and/or caregiver may access the schedule via the Internet or any other state of the art methods.

It is noted that FIG. 12 illustrates one method for the schedule generating step 714. Alternative embodiments may practice the method in a different manner. For example, the time frame (step 1204) may be selected before the format (step 1202), or the schedule may be saved (step 1214) before translation (step 1216).

Referring now to FIG. 13, an exemplary method for schedule assembly (step 1206) is shown. In steps 1302, 1304, and 1306, the profile data file, the medication and supplemental data file, and the administrative data file for the patient is accessed, respectively. The respective data from each data file is then assembled into a matrix. Thus, the personal profile data is assembled into a profile matrix in step 1308. The profile matrix is an array of information describing the patients and his/her needs. The profile matrix may be used to further create a patient's masterpage (e.g., graphical user interface) containing important patient data such as name, picture, date of birth, allergies, and any other relevant information which would help in preventing mix-ups relating to patients (e.g., the header 822 of FIG. 8B).

Similarly, the medication and supplemental data and administrative data are assembled into one or more matrices in step 1310. Each matrix is an array of information about a single medication or food supplement being utilized by the patient. Each matrix can be treated as a single, flexible element or data structure, and may include information such as name of medication, dosage, amount/allocation, time(s) of day and/or week, irregular amount and schedule, directions, general comments, and so forth.

Subsequently, the profile matrix (i.e., patient masterpage) and the medication matrices are combined in step 1312, and may be organized according to the patient's/caregiver's needs in step 1314. For example, the schedule may be organized by specific times of the day, week, and/or month, occasions, brand/generic medications, dosage(s), amount(s), directions, type of medication, frequency of use, and so forth. Furthermore, the schedule 600 may be presented according to the patient's needs such as poor eyesight, illiteracy, or any other requirements. Additionally, Rx refill due data and refill numbers may be integrated into the schedule if available.

It should be noted that FIG. 13 illustrates only one embodiment of the schedule generation step 1206, and alternative methods are contemplate. For example, while the embodiment of FIG. 13 shows the matrices assembly steps occurring in parallel, alternative embodiments may have the assembly steps occurring in series. Thus, the profile data file may be accessed and the profile matrix assembled before accessing the medication and supplement data file and the administrative data file, and assembling the corresponding matrices. In embodiments without the optional administrative module, step 1306 is removed and step 1310 only comprises assembling matrices with medication and supplemental data.

Although the present invention has been discussed with respect to specific embodiments, one of ordinary skill in the art will realize that these embodiments are merely illustrative, and not restrictive, of the present invention. For example, although the above description describes an exemplary personal computer system, it should be understood that the present invention relates to computing devices in general and need not be restricted to use in the field of medicine.

What is claimed is:

1. A system for generating a medication provider schedule comprising:
a processor;
a profile data unit configured for managing personal data for a patient;
a medication and food supplement data unit configured for managing medication or food supplement data for the patient; and
a schedule module configured to generate a schedule based on the personal data and medication or food supplement data.

2. The system of claim 1 further comprising a crossover/allergic reaction test (DUR) module configured for determining if a medication or food supplement has an adverse effect on any other medication or food supplement.

3. The system of claim 1 further comprising a medication reference and picture library configured for storing and providing information regarding medications and food supplements.

4. The system of claim 3 wherein the information are graphical representations, pictograms, or illustrations.

5. The system of claim 1 further comprising an administrative data unit configured for managing administrative data related to prescriptions and refills.

6. The system of claim 1 further comprising a database configured for storing patient data.

7. The system of claim 1 further comprising a network databank configured for providing data from a central databank.

8. The system of claim 1 further comprising a display for viewing patient data and the schedule.

9. A system for generating a medication provider schedule comprising:
a computing system configured for use by a participant or a patient for generating a schedule;
a databank server coupled in communication with the computing system, the databank server further comprising
a databank configured for storing patient data and schedule generating modules; and
a security unit configured for allowing and recording access to the databank server.

10. The system of claim 9 wherein the schedule generating modules are copied from the databank to the computing system for local operation.

11. The system of claim 9 wherein the security unit further comprises a registration module configured for registering participants or patients and verifying registered participants or registered patients.

12. The system of claim 9 wherein the security unit further comprises a logbook configured for recording access to the databank server by the participant or the patient.

13. The system of claim 9 wherein updates for the schedule generating modules are transmitted from the databank to the computing system.

14. A computer readable medium having embodied thereon a program, the program being executable by a machine to perform a method for generating a medication provider schedule comprising:
accessing patient personal profile data for a patient;
accessing medication or food supplement data for the patient; and
generating a schedule based on the patient personal profile data and the medication or food supplement data.

15. The computer readable medium of claim 14 wherein the method further comprises applying a crossover/allergic reaction test to the medication or food supplement data to determine if any adverse reactions will occur between any two medications or food supplements.

16. The computer readable medium of claim 15 wherein a warning is given if an adverse reaction will occur, and a participant is prompted to either replace or refuse a medication or food supplement.

17. The computer readable medium of claim 14 wherein the method further comprises creating personal administrative data related to a medication or food supplement for the patient.

18. The computer readable medium of claim 14 wherein the method further comprises obtaining patient data from a central databank server.

19. The computer readable medium of claim 18 wherein the method further comprises providing a valid login to the central databank server.

20. The computer readable medium of claim 14 wherein accessing patient personal profile data further comprises generating the patient personal profile data.

21. The computer readable medium of claim 14 wherein accessing medication and food supplement data further comprises generating or updating the medication and food supplement data.

22. The computer readable medium of claim 14 wherein the method further comprises translating the schedule according to the patient's or caregiver's needs.

23. The computer readable medium of claim 22 wherein the translating comprises translating the schedule into Braille.

24. The computer readable medium of claim 22 wherein the translating comprises translating the schedule into another language.

25. The computer readable medium of claim 22 wherein translating the schedule further comprises utilizing pictograms, graphical representations, or illustrations.

26. The computer readable medium of claim 14 wherein generating the schedule further comprises utilizing pictograms and graphical representations.

27. A method for generating a medication provider schedule comprising:
accessing patient personal profile data for a patient;
accessing medication or food supplement data for the patient; and
generating a schedule based on the patient personal profile data and the medication or food supplement data.

28. The method of claim 27 wherein the method further comprises applying a crossover/allergic reaction test to the medication or food supplement data to determine if any adverse reactions will occur between any two medications or food supplements.

29. A method for generating a medication provider schedule comprising:
accessing patient personal profile data for a patient;
accessing medication or food supplement data for the patient;
applying a crossover/allergic reaction test to the created medication or food supplement data to determine if an adverse reaction may result from two or more medications or food supplements;
if an adverse reaction results, replacing or refusing at least one medication of the two or more medications or food supplements which causes the adverse reaction; and
generating a schedule based on the patient personal profile data and the medication or food supplement data.

30. A generated prescription schedule comprising:
at least one image of a medication or food supplement arranged on the schedule according to when the medication or food supplement should be taken.

31. The schedule of claim 30 further comprising at least one pictogram for providing visual directions for taking at least one of the medication or food supplements.
